(19) United States
(12) Patent Application Publication
(10) Pub. No.: US 2014/0047218 A1
(43) Pub. Date: Feb. 13, 2014

(54) MULTI-STAGE REGISTER RENAMING USING DEPENDENCY REMOVAL

(71) Applicant: IMAGINATION TECHNOLOGIES LIMITED, Kings Langley (GB)

(72) Inventor: Hugh Jackson, St. Albans (GB)

(73) Assignee: IMAGINATION TECHNOLOGIES LIMITED, Kings Langley (GB)

(21) Appl. No.: 13/751,145

(22) Filed: Jan. 28, 2013

(30) Foreign Application Priority Data
Aug. 7, 2012 (GB) 1213994.5

(51) Int. Cl. G06F 9/30

(52) U.S. Cl. CPC G06F 9/30098
USPC 712/217

(57) ABSTRACT

Multi-stage register renaming using dependency removal is described. In an embodiment, the registers are renamed in two stages. The first stage involves removing all the dependencies within a set of instructions which are being renamed together. The final stage then renames all registers in parallel using a renaming map. In various embodiments, the dependencies are removed in the first stage using a fixed mapping to rename destination registers in each instruction and in some embodiments the fixed mapping is based on the position of a destination register within the set of instructions. Dependent registers, which are those registers which are read in an instruction but have been written in a previous instruction in the set, are also renamed in the first stage. In addition to performing the renaming in the final stage, the renaming map is updated.

### BACKGROUND

Out-of-order processors can provide improved computational performance by executing instructions in a sequence that is different from the order in the program, so that instructions are executed when their input data is available rather than waiting for the preceding instruction in the program to execute. In order to allow instructions to run out-of-order on a processor it is useful to be able to rename registers used by the instructions. This enables the removal of “write-after-read” (WAR) dependencies from the instructions as these are not true dependencies. By using register renaming and removing these dependencies, more instructions can be executed out of program sequence, and performance is further improved. Register renaming is performed by maintaining a map of which registers named in the instructions (called architectural registers) are mapped onto the physical registers of the processor. This map may be referred to as the ‘rename map’, ‘register map’, ‘register renaming map’, ‘register alias table’ (RAT) or similar.

Renaming is typically performed on multiple instructions in each cycle, but the data dependencies within a group of instructions being renamed in a cycle means that the operation cannot be done entirely in parallel. Every time a destination register is renamed (i.e. where the architectural register is replaced with a currently available physical register), the rename mapping (i.e. the data in the rename map) is updated. Future reads (within the group) must then use the updated mapping instead of the mapping that existed at the start of the cycle. In order to address this, forwarding paths may be used from the results of each of the destination register renaming operations to each of the future source register reads. However, this quickly becomes very complex and does not scale well (e.g. where the number of instructions processed in a group increases).

A two stage renaming method has been proposed which uses two pipelined renaming blocks. This method operates over two cycles and adopts a more asynchronous approach of using latching at intermediate points instead of the edge of the clock. Writes are performed in the first cycle and reads in the second and this leads to added complexity because in addition to dependence within a group, there is now extra dependence between the current group of instructions and the next chronological group of instructions as the two groups are updating/reading from the rename map within a single cycle.

The embodiments described below are not limited to implementations which solve any or all of the disadvantages of known methods and apparatus for register renaming.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Multi-stage register renaming using dependency removal is described. In an embodiment, the registers are renamed in two stages. The first stage involves removing all the dependencies within a set of instructions which are being renamed together. The final stage then renames all registers in parallel using a renaming map. In various embodiments, the dependencies are removed in the first stage using a fixed mapping to rename destination registers in each instruction and in some embodiments the fixed mapping is based on the position of a destination register within the set of instructions. Dependent registers, which are those registers which are read in an instruction but have been written in a previous instruction in the set, are also renamed in the first stage. In addition to performing the renaming in the final stage, the renaming map is updated.

A first aspect provides a method of register renaming in an out-of-order processor, comprising: in a first stage, removing dependencies within a set of instructions using a fixed mapping defined in hardware logic; and in a final stage, renaming all registers in the set of instructions in parallel using a renaming map.

A second aspect provides an out-of-order processor comprising: a renaming map; hardware logic defining a fixed mapping between registers; dependency removal logic arranged to remove dependencies within a set of instructions using the fixed mapping; rename logic arranged to rename all registers in the set of instructions in parallel using the renaming map; and a plurality of physical registers.

A third aspect provides an out-of-order processor substantially as described with reference to any of FIGS. 1, 5 and 6 of the drawings.

A fourth aspect provides a method of register renaming in an out-of-order processor substantially as described with reference to any of FIGS. 2-5 of the drawings.

The methods described herein may be performed by a computer configured with software in machine readable form stored on a tangible storage medium e.g. in the form of a computer program comprising computer program code for configuring a computer to perform the constituent portions of described methods. Examples of tangible (or non-transitory) storage media include disks, thumb drives, memory cards etc and do not include propagated signals. The software can be suitable for execution on a parallel processor or a serial processor such that the method steps may be carried out in any suitable order, or simultaneously.

This acknowledges that firmware and software can be valuable, separately tradable commodities. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

The preferred features may be combined as appropriate, as would be apparent to a skilled person, and may be combined with any of the aspects of the invention.

### BRIEF DESCRIPTION OF THE DRAWINGS

Embodiments of the invention will be described, by way of example, with reference to the following drawings, in which:

FIG. 1 is a schematic diagram of an example out-of-order processor;

FIG. 2 is a flow diagram of an example method of register renaming which may be implemented using the out-of-order processor shown in FIG. 1;

FIG. 3 shows an example of register renaming;

FIG. 4 shows a schematic diagram of pipelined renaming operations over four cycles;

FIG. 5 shows a schematic diagram of pipelined renaming operations over five cycles in which the dependency removal is divided into two stages and schematic diagram of another example out-of-order processor; and

FIG. 6 is a schematic diagram showing two further example out-of-order processors.

Common reference numerals are used throughout the figures to indicate similar features.

### DETAILED DESCRIPTION

Embodiments of the present invention are described below by way of example only. These examples represent the best ways of putting the invention into practice that are currently known to the Applicant although they are not the only ways in which this could be achieved. The description sets forth the functions of the example and the sequence of steps for constructing and operating the example. However, the same or equivalent functions and sequences may be accomplished by different examples.

The use of register renaming within an out-of-order processor can be described with reference to the following example which comprises two instructions (denoted I1 and I2):

I1: R3=R1+2

I2: R1=R2

Because R1 is the destination register of I2, I2 cannot be evaluated before I1 (where R1 is a source register), as otherwise the value stored in R1 is incorrect when I1 is evaluated. However, there is not a “true” dependency between the instructions, and this means that register renaming can be used to remove the dependency. For example, I2 can have its destination register renamed as follows:

I2: R4=R2

Because the destination register has been changed to R4, there is now no dependency between I1 and I2, and these two instructions can be executed out-of-order. This example shows the removal of a write-after-read (WAR) dependency. In other examples there may also be write-after-write (WAW) dependencies, for example if the instruction set further comprised a third instruction (denoted I3):

I3: R1=R5+4

This instruction (I3) writes to the same register (R1) as a previous instruction (I2), which means that the first write can be ignored, unless the operation has some other side effects.

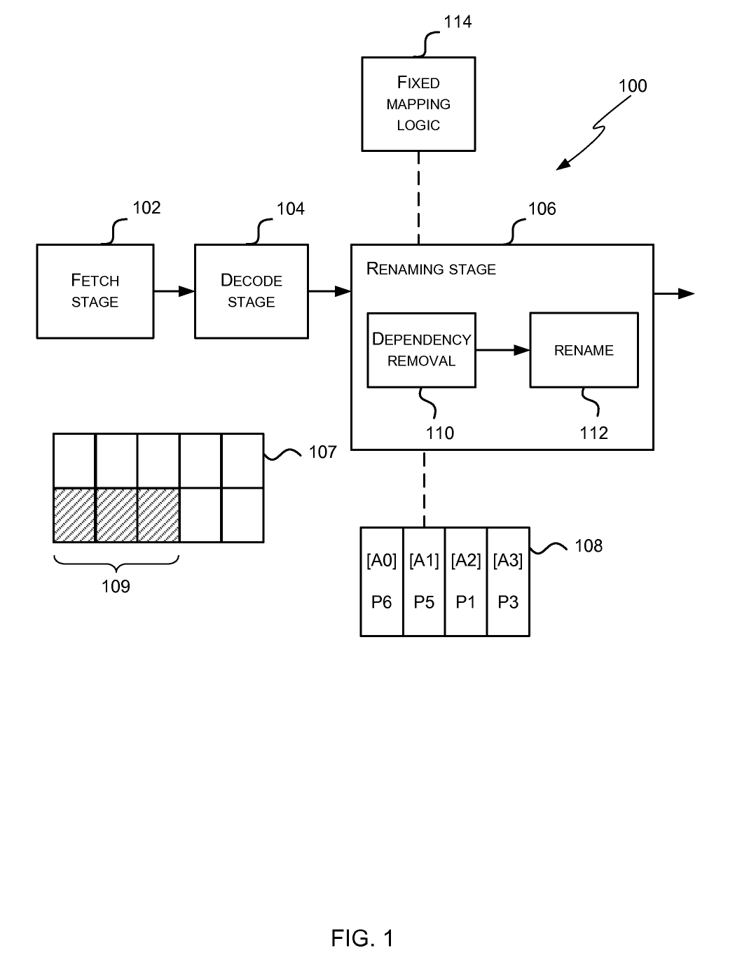

FIG. 1 shows a schematic diagram of an out-of-order processor 100 which comprises a fetch stage 102, a decode stage 104, a renaming stage 106 and a plurality of physical registers 107. It will be appreciated that the out-of-order processor may also comprise other elements not shown in FIG. 1 (e.g. re-order buffer, execution pipelines, etc.). The fetch stage 102 is arranged to fetch instructions from a program (in program order) as indicated by a program counter. The decode stage 104 is arranged to interpret the instructions before the renaming stage 106 performs register renaming. As described above, a set (or group) of instructions may be renamed at the same time. Register renaming can be performed by the renaming stage 106 using a mapping between architectural and physical registers 107 on the processor and an example register renaming map 108 is shown in FIG. 1. The register renaming map 108, which is maintained (i.e. updated) by the renaming stage 106, is a stored data structure showing the mapping between each architectural register and the physical register that was most recently allocated to it. Architectural registers are the names/identifiers of registers used in the instructions and for the purposes of the following explanation these are denoted A* (where * represents the number of a register, e.g. A0, A1 . . . ). Physical registers 107 are the actual storage locations present in the processor and these are denoted P* (e.g. P0, P1 . . . ). There are more physical registers 107 than architectural registers and the plurality of physical registers 110 comprises a plurality of unassigned physical registers 109 (as indicated by shading in FIG. 1). In the example of FIG. 1, the register renaming map 108 comprises four entries indicating the physical register identifiers (P*), indexed by the architectural register identifiers (A*). For example, architectural register 0 (A0) currently maps to physical register 6 (P6), architectural register 1 (A1) currently maps to physical register 5 (P5), etc. The renaming map 108 may be stored in flip-flops within the processor hardware logic.

As shown in FIG. 1, the renaming stage 106 is divided into two stages: dependency removal 110 and rename 112, although as described in more detail below there may be more than two stages (e.g. the dependency removal stage 110 may be divided into two or more sub-stages). The first of these stages, dependency removal 110, removes the dependencies within a set (or group) of instructions which are being renamed in parallel. Both RAW and WAW dependencies are removed for the instructions within the set in this stage through the use of a fixed mapping which is entirely predictable, is independent of any previous state and is implemented in hardware logic 114. As described in more detail below, the fixed mapping maps destination and dependent registers within the set of instructions to intermediate registers (denoted N*). By using such a fixed mapping, where the mapping is linked to the physical location of an instruction within a set, only a minimal amount of logic (e.g. hardware logic) is required to implement this stage. This first stage does not use the renaming map (which is not a fixed mapping but instead stores a dynamic mapping that can change with each cycle) or require any look-ups to be performed (e.g. look-ups in a fixed data structure).

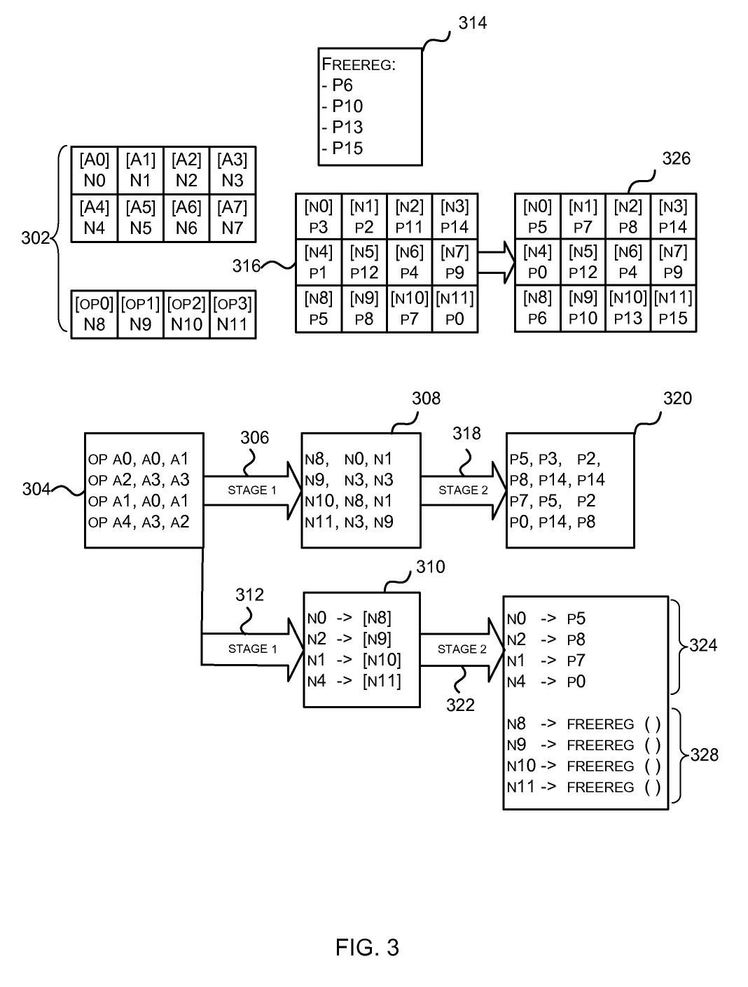

The second of these stages, rename 112, (which may also be called the final stage) then renames all the registers in parallel using the renaming map 108 (e.g. from intermediate registers to physical registers). In this way, the rename stage performs all the reads and updates to the renaming map in parallel (i.e. all the updates are set up at the same time as performing all the reads, but the updates do not take effect until the clock edge so that the reads will not see the effects of the current updates), which makes this final stage very scalable (e.g. to large numbers of instructions in the same cycle). The renaming map which is used includes the additional register mapping, as shown in FIG. 3 and described below.

Although the methods show the renaming map 108 being updated (in block 208) in each cycle, it will be appreciated that there may be situations where no changes are required and in such an instance the step of updating the renaming map will leave the map unchanged.

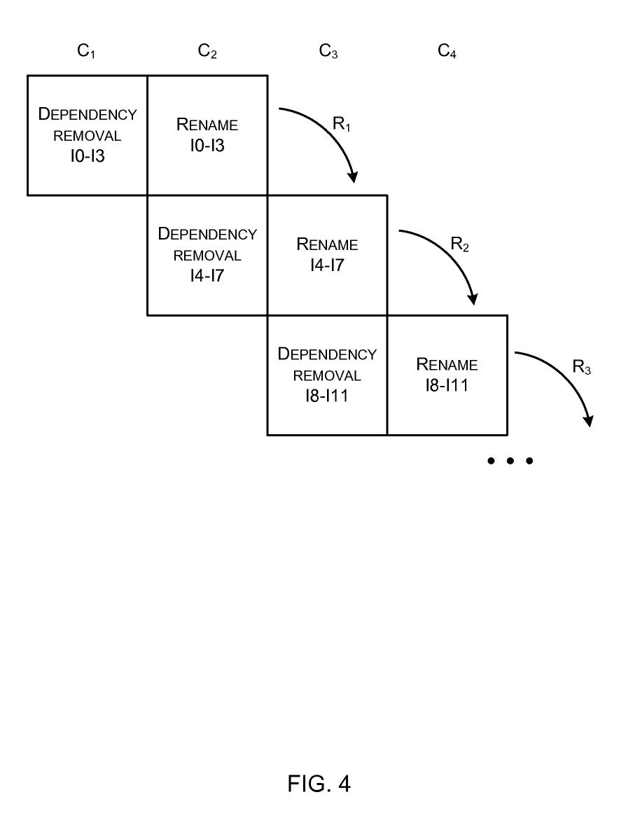

The division of the renaming stage 106 into two stages in this way has the effect that the renaming operation takes two cycles, which increases the latency compared to a single cycle single stage operation, but does not reduce the throughput as the two stages are easily pipelined (as described in more detail with reference to FIG. 4). By using this method it is possible to increase the throughput (by increasing the number of instructions in a set) and/or increase the maximum clock speed.

Both the dependency removal and rename stages 110, 112 may be implemented entirely in hardware logic within a processor. Alternatively, some or all of the method steps may be implemented in software. The processor may be a single-threaded processor or a multi-threaded processor. Where the processor is a multi-threaded processor, the elements shown in FIG. 1 may be replicated for each thread, such that each thread has a local set of architectural registers and a renaming stage 106. An alternative multi-threaded processor may share some or all of the hardware logic (block 106) to do the actual rename, where the thread number may be used in conjunction with the register number to index the renaming map 108 (i.e. where the renaming map relates to more than one thread). For example, the renaming map may have an entry mapping architectural register 0 (A0) for thread 0 to physical register 6 (P6) and a separate entry mapping he same architectural register (A0) for thread 1 to physical register 26 (P26).

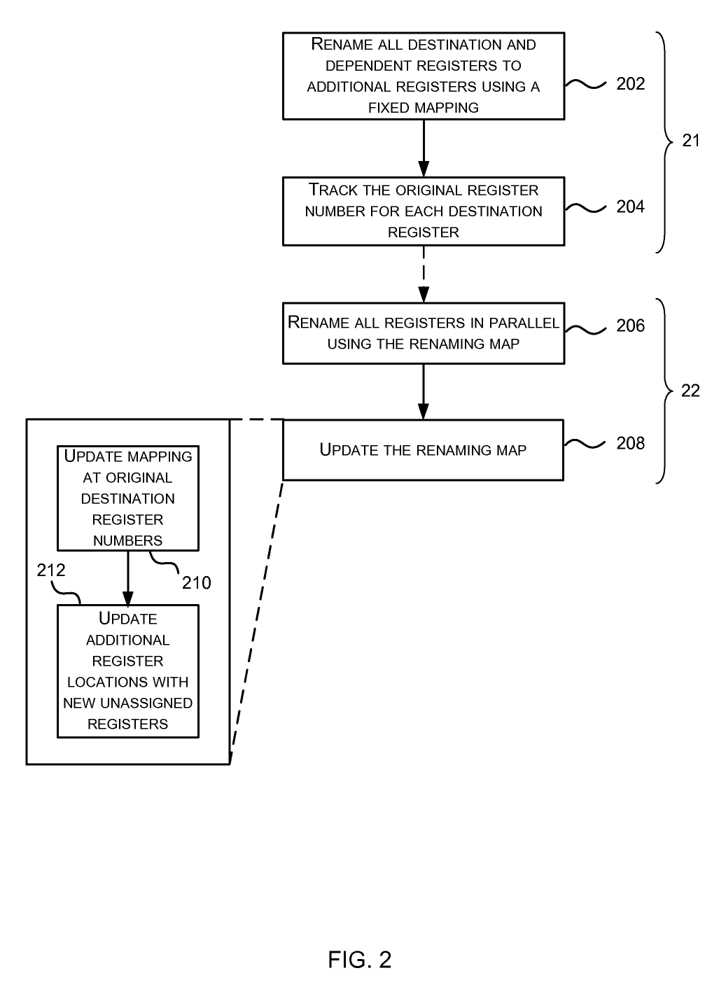

FIG. 2 shows a flow diagram of an example method of operation of the renaming stage 106. In the first stage 21, which is performed by the dependency removal stage 110 shown in FIG. 1, all the destination and dependent registers are renamed to additional registers using a fixed mapping (block 202). The term ‘dependent registers’ is used herein to refer to those registers which are read in an instruction and which are also written to by a previous instruction in the set (i.e. any source registers which are a destination register in a previous instruction in the set). For the purposes of the following explanation, the destination registers may be denoted OP* where * represents the number of the instruction.

The number of additional registers which are used (e.g. N additional registers) is equal to the maximum number of destination registers within the set. In many examples, each instruction writes to only one destination and in such examples, the number of additional registers used is equal to the number of instructions in the set which are being renamed together (e.g. N instructions in the set). For example, where the set of instructions comprises:

I1: R3=R1+2

I2: R1=R2

I3: R5=R1+4

there will be three additional registers used (N=3). One additional register will be used for the destination register (R3) of the first instruction (I1), another additional register will be used for the destination register (R1) of the second instruction (I2) and a third additional register will be used for the destination register (R5) of the third instruction (I3). In this example, there is one dependent register which is source register R1 in the third instruction (I3) because this register has been written in a previous instruction in the set (i.e. in the second instruction, I2). In other examples, however, an instruction may have more than one destination register and consequently the number of additional registers used may exceed the number of instructions in the set.

The fixed mapping used in this first stage (block 201) and in this example may be as shown in the table below, which uses the notation N*.

| | | | | | | | | | | |
|---|---|---|---|---|---|---|---|---|---|---|
| [A0] | [A1] | [A2] | [A3] | [A4] | [A5] | [A6] | [A7] | [OP1] | [OP2] | [OP3] |
| N0 | N1 | N2 | N3 | N4 | N5 | N6 | N7 | N8 | N9 | N10 |

The registers N0-N7 are an exact representation of the architectural registers A0-A7 (where 8 architectural registers are used by way of example only) and the three additional registers are N8, N9 and N10. These extra registers (N8-N10) map to three of a pool of unassigned (or free) physical registers. In this example, the destination registers (OP1, OP2) are renamed in chronological order which simplifies the logic, although they may be renamed in any order (although, once implemented the same order will be used for each cycle, as this is a fixed mapping). The unassigned physical registers can be any registers and do not need to be adjacent registers, as demonstrated by the example shown in FIG. 3 and described below. Following this dependency removal, the instructions may be written (using an intermediate N* notation):

I1: N8=N1+2

I2: N9=N2

I3: N10=N9+4

It can be seen from this example that the dependent register (R1) in the third instruction (I3) has been renamed (to N9) to correspond to the register that was written to in the previous instruction (I2).

In order that the corresponding entries for each of the destination registers (R3, R1, R5) in the renaming map can be updated with the new physical register in the rename stage (i.e. in the next cycle), the original register number for each destination register is tracked (block 204), i.e. details are stored which identify which additional register was used to rename each of the destination registers (e.g. in flip-flops between the two renaming stages). Referring back to the example above, this involves tracking the following information:

N3→[N8]

N1→[N9]

N5→[N10]

where [N8] denotes the contents of the renaming map location N8.

The final stage 22, which is performed by the rename logic 112 shown in FIG. 1, then performs all the renaming of registers in parallel using the renaming map (block 206). As described above, the renaming map 108 is a stored data structure which is updated (and stored) by the renaming stage 106 each cycle and so the renaming map used in any cycle is the map as updated in the previous cycle. In order to perform the renaming, the stored renaming map is accessed and used to rename all the registers in parallel (in block 206). This requires read operations on the renaming map. At the same time (e.g. in parallel with the read operations), the renaming map is updated (block 208), i.e. the updates to the renaming map are set-up, but do not take effect until the clock edge, at which point all of the flip-flops used to create the renaming map will update, thereby storing the updated map. There are two sets of writes/updates to the renaming map which are performed (in block 208). Firstly, the renaming map is updated based on the information that was tracked (in block 204) in the first stage such that the mappings at the original destination register numbers is updated to the value currently in the additional register location associated with that instruction (block 210). Secondly, the additional register locations (N8-N10 in the example above) which are no longer pointing at unassigned physical registers (as they have just been assigned) are updated with a new set of unassigned physical registers from a pool of unassigned physical registers (block 212). It will be appreciated that these two update steps may be performed in parallel or in either order (e.g. block 210 followed by block 212 or vice versa).

It will be appreciated that although FIG. 2 shows block 206 occurring before block 208, as described above, the read and update (or write) operations in these two blocks may be performed in parallel, with the writes being set-up during the cycle and then taking effect at the clock edge (i.e. so that the writes take effect after the reads and there is no possibility that incorrect data can be read).

This method may be further described with reference to the example shown in FIG. 3. In this example, the instructions are renamed in sets of four and so there are four additional registers denoted N8-N11. Again in this example, the original destination registers (OP0-OP3) are assigned in chronological order to simplify the logic used to implement the step in hardware, as shown in the fixed mappings 302. In this example, the original instructions 304 are written in the format ‘OP Rd, Rs1, Rs2’ where Rd is a destination register and Rs is a source register. So taking the first instruction in FIG. 3 as an example, which reads ‘OP A0, A0, A1’, the destination register is architectural register A0 and the source registers are architectural registers A0 and A1.

In the first stage 21 of the renaming operation, all the destination and dependent registers are renamed using the fixed mapping 302 (block 202 and arrow 306). The resultant list 308 of renaming map reads which are required for instructions is shown in FIG. 3 in the intermediate register notation (i.e. using N* notation for all registers). It can be seen from this example that the destination registers OP A0, OP A2, OP A1 and OP A4 have been renamed to the four additional registers N8-N11. The dependent registers have also been identified and renamed to the appropriate additional register, i.e. the read of A0 in the third instruction has been modified to N8 as the first instruction modified the value of A0 and the read of A2 in the fourth instruction has been modified to N9 as the second instruction modified the value of A2. Where source registers are not dependent registers, there is a one to one mapping from the A* notation to the N* notation, as shown in the fixed mapping 302.

In addition to the renaming in the first stage (block 202 and arrow 306), the list of rename map updates 310 which are required for instructions are identified (block 204 and arrow 312). As described above, the notation [N8] denotes the contents of the renaming map location N8.

The resultant list 308 of renaming map reads and the list of rename map updates 310 may be stored in flip-flops within the hardware logic between the two renaming stages 21, 22.

It can be seen that at the end of this first stage, there are no RAW or WAW dependencies within the set of instructions being renamed.

In order to perform the final stage 22 of the renaming operation, two pieces of information are used: a list of available (physical) registers for renaming 314 and the current renaming map 316. As described above, this final stage is implemented in a second cycle. In this final stage 22, all the registers are renamed in parallel using the renaming map 316 (block 206 and arrow 318) and the resultant renamed operands of the instructions 320 are shown in physical register notation (i.e. P* notation). The term ‘operand’ is used herein to refer to a register within an instruction.

The updating of the renaming map (block 208 and arrow 322) is also shown in FIG. 3 and as described above, this updating comprises two parts: updating the original destination register numbers (block 210) and updating the additional register locations (block 212).

In one part (block 210) of the updating of the renaming map, four entries in the renaming map are updated (updates 324) using the mapping update information 310 generated in the first stage and the renaming map 316. For example, in the first stage it was recorded that register N0 maps to the contents of the rename map location N8, which in renaming map 316 is physical register P5. Consequently in updating the renaming map (to generate the output renaming map 326), the contents of rename map location N0 is changed from P3 to P5. The contents of rename map locations N2, N1 and N4 are changed similarly from P11, P2 and P1 to P8, P7 and P0 respectively.

In the other part (block 212) of the updating of the renaming map, four entries in the renaming map are also updated (updates 328). The renaming map is updated such that the additional registers N8-N11 map to free registers from the list of available registers 314 and in this example, the contents of rename map locations N8-N11 are changed from P5, P8, P7, P0 (which are physical registers which had previously been free but are now assigned) to P6, P10, P13, P15. Although in this example, the available registers are allocated in chronological order, in other examples the available physical registers may be mapped to the additional architectural registers in any order. This part resets the additional registers back to free registers so that the same fixed mapping can be used in each iteration of the dependency removal stage (i.e. for each set of instructions which are renamed).

Having updated the renaming map (in block 208), the updated renaming map (which may also be referred to as the output renaming map) will be used in renaming the next set of instructions in the following cycle and this pipelining of the renaming process is shown in FIG. 4. FIG. 4 shows a schematic diagram of renaming operations over four cycles C₁-C₄. In the first cycle, C₁, the dependencies are removed (in blocks 202-204) from a first set of instructions (I0-I3). In the second cycle, C₂, the first set of instructions (I0-I3) are renamed using an initial renaming map R₀ (in block 206) and this map is updated (in block 208) to generate an updated renaming map R₁. In parallel in the second cycle C₂, a second set of instructions (I4-I7) have their dependencies removed (in blocks 202-204). In the third cycle, C₃, the second set of instructions (I4-I7) are renamed using the renaming map R₁ output from the previous cycle (in block 206) and this map is updated (in block 208) to generate a further updated renaming map R₂. In parallel in the third cycle C₃, a third set of instructions (I8-I11) have their dependencies removed (in blocks 202-204). This process may then be repeated for any remaining sets of instructions.

It can be seen from FIG. 4 that the two stages (dependency removal and rename) can easily be pipelined as each stage is detached from the other such that they do not share bits of logic or the renaming map. As described above, the method described herein has reduced forwarding due to dependencies, both within a set of instructions and between sets of instructions, compared to other two stage renaming processes which instead separate read and write operations. It can also be seen that only one set of instructions is updating/reading from the renaming map within a single cycle. This is because the first stage (dependency removal) does not use the renaming map but instead uses a fixed mapping.

It can also be seen from FIG. 4 that although the latency of the renaming has increased by a cycle (compared to a single stage renaming block) due to the use of a two-stage renaming process, the throughput remains at one set of instructions per cycle (which comprises four instructions in this example). However, as each stage is of low complexity, it is possible to increase the number of instructions within each set whilst maintaining the same clock speed as a single cycle renaming block and as a result the overall throughput is higher. Alternatively, clock speed can be increased for the same throughput (as a single stage renaming block) and where the same throughput is required, the two stage system may be implemented such that it takes less silicon area (which reduces costs). This smaller area can be achieved because the dependency renaming step can be implemented in only a small amount of logic as a result of the fixed mapping. In other examples, a combination of increased clock speed and increased throughput may be achieved.

The method described above relies on the availability of unassigned physical registers which can be used as additional registers in the renaming operation. If a point is reached where there are no more available registers (e.g. at the end of C₃ in FIG. 4), the method may be allowed to stall such that the renaming operation stops until registers become available (e.g. renaming of I8-I11 is delayed) and stalling the method in this way may be no more problematic than in existing single cycle implementations. As shown in FIG. 3, the only state which is maintained is the renaming map 316, 326. The rename map reads 308 and updates 310 are not truly retained but instead are passed from one stage of the renaming to the next, for example by writing the information to flip-flops at the end of the first stage (i.e. at the end of one cycle) and then using the flip-flop values in the final stage (i.e. in the next cycle). The method may also be stalled in different circumstances, such as where there is a lack of available resource in the backend of the processor.

In the description above relating to FIG. 3, each set of instructions comprised four instructions. This is by way of example only and it will be appreciated that the set of instructions may have any number of instructions and in some examples, the sets of instructions may have very large numbers of instructions. In an example where the sets of instructions comprise a large number of instructions, the first stage 21 may be divided into two or more sub-stages which each remove the dependencies within a subset of the set of instructions.

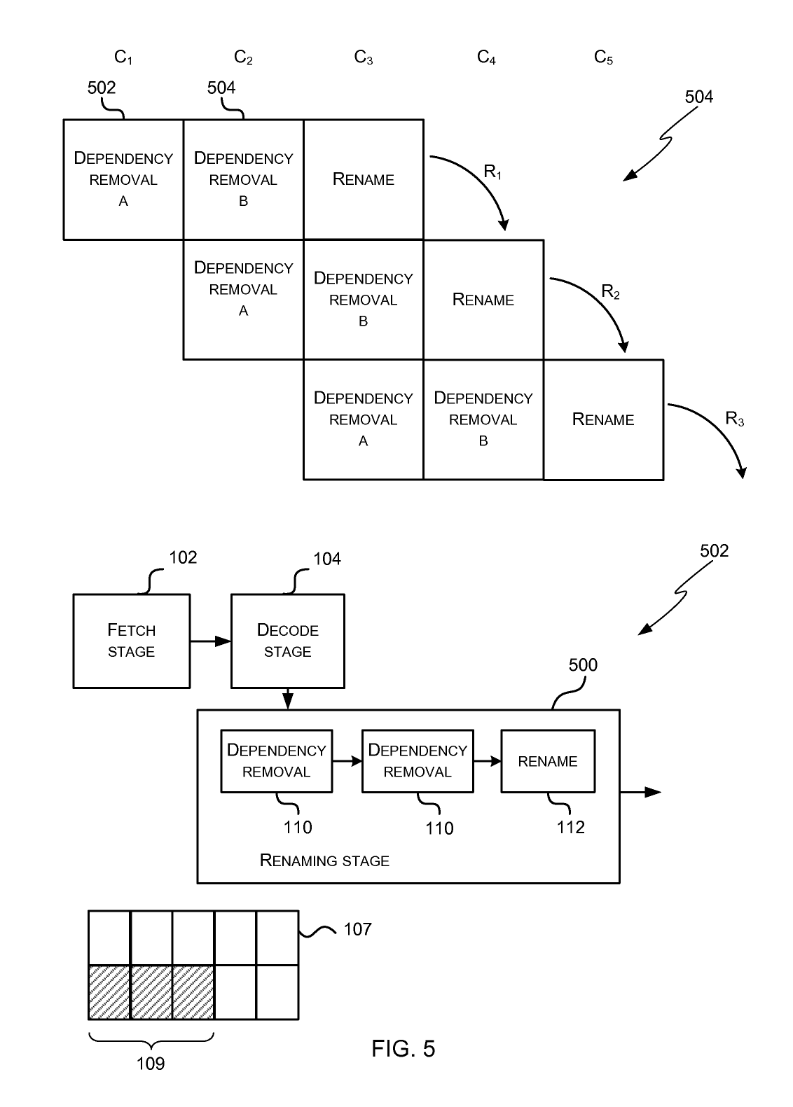

FIG. 5 shows an example in which the renaming stage 500 within the out-of-order processor 502 comprises two instances of the dependency removal logic 110 and as shown in the timing diagram 504, throughput is not impacted compared to the two-stage approach shown in FIG. 4 (it is still one set of instructions per cycle) but there is one additional cycle of latency (i.e. the renaming operation takes a total of three cycles in this example, compared to the two cycles shown in FIG. 4).

In the first dependency removal sub-stage (‘Dependency Removal A’), all of the instructions in the set (e.g. I0-I39 for a set comprising 40 instructions) are checked for dependencies with the first half (or first subset) of destination registers (e.g. destination registers for I0-I19). In the second dependency removal sub-stage (‘Dependency Removal B’), the second half of the instruction sources are checked for dependencies with the second half of destination registers (e.g. destination registers for I20-I39). In the second sub-stage it is not necessary to check the first half of the instruction sources as they cannot be dependent on the destinations of the second half instructions (as any read of a register in an instruction in the first half would be happening before a write to the same register in an instruction in the second half).

The following table shows an example for an instruction set comprising 4 instructions. In the first sub-stage, all instructions (I0-I3) are checked for dependencies with the destination registers in the first two instructions (e.g. A0, A3) and all source registers are renamed with the original register names also being tracked. The results are shown in the column entitled ‘after half dependence removal’ in the table. The original register names are tracked in case a later dependency is found in the second sub-stage (e.g. as in the case of the last instruction in this example, where the renaming of N4 is replaced by N10). It will be appreciated that instead of renaming all registers and tracking original register names, the registers may not be renamed in this first sub-stage but the renaming may be tracked for later implementation (e.g. as part of the last sub-stage).

In the second sub-stage, the second half of the instructions sources (e.g. the sources of instructions I2 and I3) are checked for dependencies with the destination registers in the second half of the instructions (e.g. A4, A5).

| | | After full |
|---|---|---|
| | After half dependence | dependence |
| Input | removal | removal |
| OP A0, A1, A2 | N8, N1, N2 | N8, N1, N2 |
| | N0 -> [N8] | N0 -> [N8] |
| OP A3, A0, A1 | N9, N8, N1 | N9, N8, N1 |
| | N3 -> [N9] | N3 -> [N9] |
| OP A4, A3, A0 | A4, A3, A0 | N10, N9, N8 |
| | N9, N8 | N4 -> [N10] |
| OP A5, A6, A4 | A5, A6, A4 | N11, N6, N10 |
| | N6, N4 | N5 -> [N11] |

Where more than two dependency removal sub-stages are used, for example n sub-stages, the i^{th} sub-stage checks instructions in subsets i to n for dependencies with the destination registers in the i^{th} subset of the instructions (e.g. for n=3, the 2^{nd} sub-stage checks instructions in subsets 2 and 3 for dependencies with the destination registers in the 2^{nd} subset of instructions).

So, by increasing the number of instructions in a set significantly, such that two or more dependency removal stages are used, throughput can be increased at the expense of latency. As the final stage 22 is easily scaled the entire set of instructions (e.g. I0-I39 in the 40 instruction example) may be renamed in parallel and so there is a single instance of the rename logic 112.

The methods described above show example implementations using additional registers to perform register renaming. It will be appreciated, however, that the N unassigned physical registers which are used in renaming (to update the map and instructions), may be assigned to in different ways without affecting the overall technique described herein (e.g. using a FIFO methodology or other approach). For example, the additional registers may feed into each other, where not all the additional registers are used in a particular cycle, e.g. where there are 3 additional (intermediate) registers, N0, N1, N2 and only N0 and N1 are used, then the value of N2 (i.e. the unassigned register corresponding to N2) could be put in N0 (N0→[N2]) and N1 and N2 could get new unassigned physical registers. Similarly, if only N0 was used, the value of N1 could be put in N0 and the value of N2 in N1 (N0→[N1] and N1→[N2]) and N2 could get a new unassigned physical register.

In the examples described above, there is the same number of instructions in each set. In further examples, however, different sets may comprise different numbers of instructions and in such examples, there may be a maximum number of instructions which can be accommodated within a set. In some implementations, the number of instructions within a set may be varied according to the number of instructions that the decode stage 104 is able to send to the renaming stage 106, 500 in any particular cycle. Furthermore, where multiple dependency removal sub-stages are used, each subset of instructions does not need to comprise the same number of instructions (e.g. where two dependency removal sub-stages are used, the first subset may comprise more than half or less than half the instructions in the set).

In the examples described above, all the instructions being renamed have the same number of destination operands (one in the examples above) and the same number of source operands (one in the first example above and two in the example shown in FIG. 3). In a variation of the methods described above, instructions may have a variable, bounded number of operands (e.g. up to X sources and up to Y destinations, where X and Y may be the same or may be different). In such an implementation, each operand (e.g. destination or source register) up to the maximum permitted number of operands, may have a valid bit associated with it which indicates whether the operand is being used or not. For example, where X=3 and Y=2, there will be five valid bits associated with each instruction, even though that instruction may comprise fewer than five operands. Where the bit identifies that the operand is being used, it is renamed using the methods described above, however, where the bit identifies that the operand is not being used, the unused operand is skipped (or ignored) by the renaming operation.

In situations where there is a fixed number of destinations and a variable number of sources, such a valid bit may be used for each source operand or alternatively each source operand may be implicitly valid. Performing the renaming operation on unused source operands is inefficient, but performing renaming on unused destination operands will not work. For this reason, in some implementations, valid bits may only be used in relation to destination operands and not source operands.

In an example where only a small number of instructions have more than one destination register, it may be more efficient to separate each instruction which has more than one destination register into a series of sub-instructions, with each sub-instruction having a maximum of one destination register. The set of instructions, including the sub-instructions, may then be renamed using the methods described above and without the need for valid bits.

In some examples, additional renaming optimization techniques may be added in between the two stages of the renaming process or as part of either the first or final stages. In particular, with many renaming optimizations, the ability to add the optimization step after dependencies have been removed but before writing to the renaming map may improve the efficiency of the process and the multi-stage renaming process described herein is well suited to such insertion of additional operations between the stages. In an example, where an instruction moves the value of one architectural register to another architectural register (e.g. A0=A1), then this could be implemented by updating the mapping in an optimization step rather than by subsequently executing the instruction.

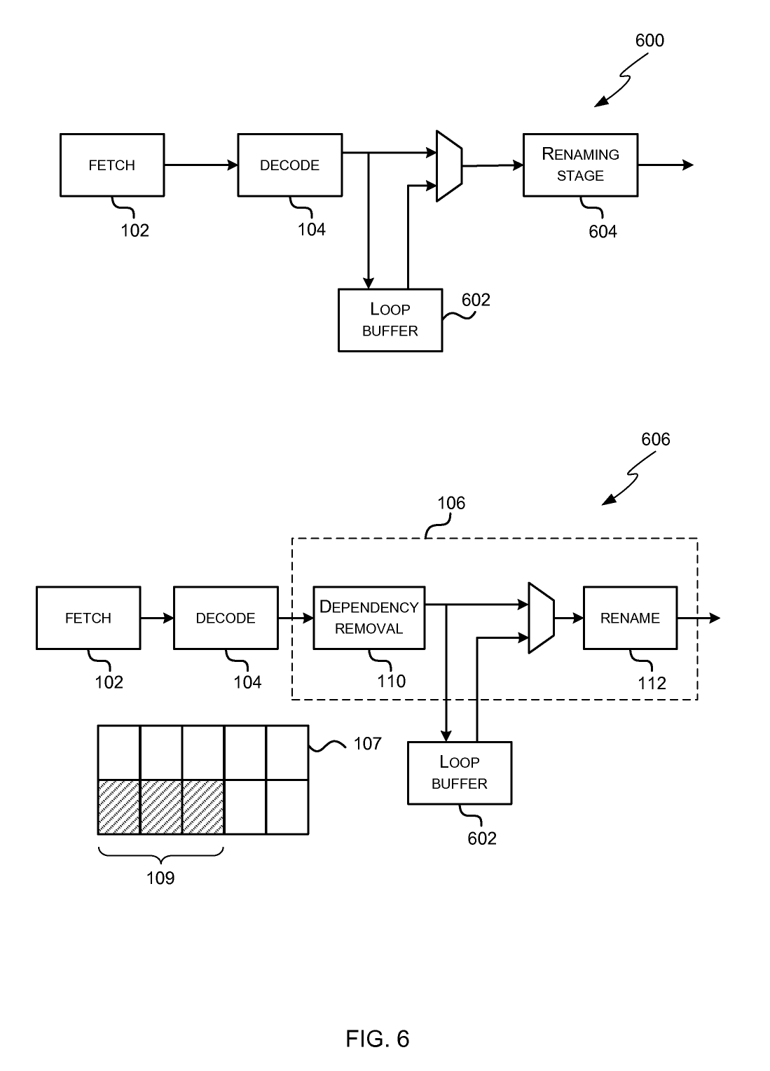

FIG. 6 shows two schematic diagrams of out-of-order processors which each comprise a loop buffer. The first example processor 600 shows an arrangement in which the loop buffer 602 is located after the fetch and decoding stages 102 and 104 and before the renaming stage 604. In operation, if the start of a loop is detected, the instructions are collected together in the loop buffer 602 before the renaming stage 604. When the entire loop is in the loop buffer 602, the fetching and decoding operations may be stopped and instead the instructions may be fed from the loop buffer 602 to the renaming stage 604. In this configuration the execution of the instructions in the loop is affected by bottlenecks in the renaming stage 604.

The second example processor 606 shows an improved arrangement in which the loop buffer 602 is located between the two stages 110, 112 of the renaming stage 106. In this second, optimized, example, the instructions are stored in the loop buffer 602 after the dependencies have been removed (in the dependency removal stage 110) but before the rename stage. Once the entire loop is stored within the loop buffer 602, the rename stage 112 can rename the instructions in the loop in a small number of operations. As described above, the rename stage 112 can perform all the renaming operations in parallel (in block 206) and is very scalable (and much more scalable than the dependency removal stage 110) and in some instances it may be possible to rename the entire loop in a single operation (i.e. in a single cycle). Use of such an architecture (i.e. the multi-stage renaming architecture described herein) significantly reduces the delay which is introduced by the renaming of loops because the loop buffer can be placed after the stage which is most constrained in capacity.

The methods and renaming apparatus described above provide a more scalable renaming operation which, whilst increasing latency by a small number of cycles (e.g. one or more) increases throughput and/or maximum clock speed. In addition, because the dependencies are all removed in the first stage, which eliminates the need for complicated forwarding paths or latches between operations, the system can be more easily synthesized than alternative two-stage renaming techniques.

Compared to an equivalent single stage renaming block, there are less logic levels (e.g. fewer gates cascaded) and this has the effect that the maximum clock speed of the renaming block is higher.

The term ‘processor’ and ‘computer’ are used herein to refer to any device with processing capability such that it can execute instructions. The term ‘processor’ is used herein to include microprocessors, multi-threaded processors and single-thread processors. In some examples, for example where a system on a chip architecture is used, a processor may include one or more fixed function blocks (also referred to as accelerators) which implement a particular function (e.g. part of a method implemented by the processor) in hardware (rather than software or firmware). Those skilled in the art will realize that such processing capabilities are incorporated into many different devices and therefore the term ‘computer’ includes set top boxes, media players, digital radios, PCs, servers, mobile telephones, personal digital assistants, games consoles and many other devices.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

A particular reference to “logic” refers to structure that performs a function or functions. An example of logic includes circuitry that is arranged to perform those function(s). For example, such circuitry may include transistors and/or other hardware elements available in a manufacturing process. Such transistors and/or other elements may be used to form circuitry or structures that implement and/or contain memory, such as registers, flip flops, or latches, logical operators, such as Boolean operations, mathematical operators, such as adders, multipliers, or shifters, and interconnect, by way of example. Such elements may be provided as custom circuits or standard cell libraries, macros, or at other levels of abstraction. Such elements may be interconnected in a specific arrangement. Logic may include circuitry that is fixed function and circuitry can be programmed to perform a function or functions; such programming may be provided from a firmware or software update or control mechanism. Logic identified to perform one function may also include logic that implements a constituent function or sub-process. In an example, hardware logic has circuitry that implements a fixed function operation, or operations, state machine or process.

Any range or device value given herein may be extended or altered without losing the effect sought, as will be apparent to the skilled person.

It will be understood that the benefits and advantages described above may relate to one embodiment or may relate to several embodiments. The embodiments are not limited to those that solve any or all of the stated problems or those that have any or all of the stated benefits and advantages.

Any reference to an item refers to one or more of those items. The term ‘comprising’ is used herein to mean including the method blocks or elements identified, but that such blocks or elements do not comprise an exclusive list and apparatus may contain additional blocks or elements and a method may contain additional operations or elements.

The steps of the methods described herein may be carried out in any suitable order, or simultaneously where appropriate. The arrows between boxes in the figures show one example sequence of method steps but are not intended to exclude other sequences or the performance of multiple steps in parallel. Additionally, individual blocks may be deleted from any of the methods without departing from the spirit and scope of the subject matter described herein. Aspects of any of the examples described above may be combined with aspects of any of the other examples described to form further examples without losing the effect sought. Where elements of the figures are shown connected by arrows, it will be appreciated that these arrows show just one example flow of communications (including data and control messages) between elements. The flow between elements may be in either direction or in both directions.

It will be understood that the above description of a preferred embodiment is given by way of example only and that various modifications may be made by those skilled in the art. Although various embodiments have been described above with a certain degree of particularity, or with reference to one or more individual embodiments, those skilled in the art could make numerous alterations to the disclosed embodiments without departing from the spirit or scope of this invention.

1. A method of register renaming in an out-of-order processor, comprising:
in a first stage, removing dependencies within a set of instructions using a fixed mapping defined in hardware logic; and
in a final stage, renaming all registers in the set of instructions in parallel using a renaming map.

2. A method according to claim 1, wherein removing dependencies within a set of instructions using a fixed mapping defined in hardware logic comprises:
renaming all destination registers and any dependent registers within the set of instructions with one of a set of additional registers using the fixed mapping; and
passing details of which additional register was used to rename each destination register to the final stage.

3. A method according to claim 2, wherein the fixed mapping between destination registers and additional registers is based on a physical position of each destination register in the set of instructions.

4. A method according to claim 1, wherein the final stage further comprises:
updating the renaming map.

5. A method according to claim 4, wherein the renaming map comprises entries associated with each additional register.

6. A method according to claim 5, wherein updating the renaming map comprises:
updating entries in the renaming map associated with each destination register based on details passed from the first stage; and
updating entries in the renaming map associated with each additional register to map each additional register to an unassigned physical register.

7. A method according to claim 6, further comprising:
accessing a list of unassigned physical registers.

8. A method according to claim 1, wherein the fixed mapping is independent of any previous state.

9. A method according to claim 1, further comprising:
performing an optimization operation between the first stage and the final stage.

10. A method according to claim 2, wherein the set of instructions comprises N instructions and the set of additional registers comprises N additional registers, where N is an integer.

11. A method according to claim 1, wherein each instruction within the set of instructions comprises no more than Y destination registers and wherein each instruction has a set of Y associated valid bits, each valid bit indicating whether one of the Y destination registers is used in the instruction.

12. A method according to claim 11, wherein the set of instructions comprises N instructions and the set of additional registers comprises N×Y additional registers, where N and Y are integers.

13. A method according to claim 1, wherein each instruction within the set of instructions comprises no more than X source registers and wherein each instruction has a set of X associated valid bits, each valid bit indicating whether one of the X source registers is used in the instruction.

14. An out-of-order processor comprising:
a renaming map;
hardware logic defining a fixed mapping between registers;
dependency removal logic arranged to remove dependencies within a set of instructions using the fixed mapping;
rename logic arranged to rename all registers in the set of instructions in parallel using the renaming map; and
a plurality of physical registers.

15. An out-of-order processor according to claim 14, wherein the dependency removal logic comprises a plurality of dependency removal logic instances, and wherein each dependency removal logic instance is arranged to remove dependencies within a separate, non-overlapping subset of the set of instructions.

16. An out-of-order processor according to claim 14, wherein the dependency removal logic is arranged to remove dependencies within a set of instructions by renaming all destination registers and any dependent registers within the set of instructions with one of a set of additional registers using the fixed mapping; and passing details of which additional register was used to rename each destination register to the rename logic.

17. An out-of-order processor according to claim 14, wherein the renaming map comprises entries associated with each additional register.

18. An out-of-order processor according to claim 14, wherein the plurality of physical registers comprises a plurality of unassigned physical registers.

19. An out-of-order processor according to claim 14, wherein the rename logic is further arranged to update the renaming map.

20. An out-of-order processor according to claim 14, further comprising a loop buffer between the dependency removal logic and the rename logic, wherein the loop buffer is arranged to store instructions located within a loop after dependency removal by the dependency removal logic; and once all instructions in the loop are stored, to release the instructions to the rename logic.
